(19) United States
(12) Patent Application Publication
(10) Pub. No.: US 2010/0018593 A1
(43) Pub. Date: Jan. 28, 2010

(54) CHECK VALVE MECHANISM FOR RODENTS AND/OR ODORS

(76) Inventor: Pasquale Farruggia, Quebec (CA)

Correspondence Address: OGILVY RENAULT LLP, 1, Place Ville Marie, SUITE 2500, MONTREAL, QC, H3B 1R1, CA

(21) Appl. No.: 12/510,530

(22) Filed: Jul. 28, 2009

Related U.S. Application Data
(63) Continuation of application No. 11/687,289, filed on Mar. 16, 2007, now abandoned.
(60) Provisional application No. 60/782,620, filed on Mar. 16, 2006.

(51) Int. Cl. F16K 15/03

(52) U.S. Cl. 137/527

(57) ABSTRACT

A check valve mechanism for use with a vertical drain pipe comprises a connector portion for supporting the check valve mechanism with respect to the drain pipe, and two flaps, each being an ungula of a cylindrical tube. The flaps are pivotally connected to the connector portion, so as to be displaceable between a closed position in which the flaps are against one another such that peripheral portions of the flaps are collinear at a connection line to obstruct the drain pipe, and an opened position, in which the flaps are away from one another to allow liquids/solids to pass through the check valve mechanism and the flaps.

### CROSS-REFERENCE TO RELATED APPLICATION

This patent application is a continuation of U.S. patent application Ser. No. 11/687,289, filed on Mar. 16, 2007, and claims priority on U.S. Provisional Patent Application No. 60/782,620, filed on Mar. 16, 2006, by the present applicant.

### BACKGROUND OF THE INVENTION

1. Field of the Invention

The present invention generally relates to plumbing accessories used in draining systems and sewer systems and, more particularly, to a check valve mechanism forming a rodent barrier for drain pipes, and forming an odor barrier for floor drains.

2. Background Art

One of the primary functions of drain pipes is to provide a conduit for the evacuation of human waste toward sewer systems. Accordingly, check valve systems or like rodent barriers have been used to allow the evacuation of human waste therethrough, while blocking the pipes to prevent infiltration by rodents. U.S. Pat. No. 5,481,766, issued to Steadman on Jan. 9, 1996, describes a toilet guard consisting of a guard tube and a plurality of flexible, resilient wires having their base ends connected to the tube. The free ends of the wires extend radially inward in a truncated conelike formation. The wires spread radially outward to permit human waste and wads of toilet paper to pass through. The wires move radially inward, and hence obstruct the passage when pressed by the animal.

Although U.S. Pat. No. 5,481,766 teaches a configuration enabling human waste and wads of toilet paper to pass through, the human waste and wads of paper nonetheless meet the wires on their way down the drain pipe. Therefore, the flow of liquids/solids is not free of obstacles on its way down the drain pipe.

In designing check valve mechanisms for rodents used in drain pipes, a few factors must be considered. The check valve mechanisms must interfere as little as possible with the flow of water evacuating human waste and wads of toilet paper, and should be easy to install and remove in the event that there is a need to unblock the drain pipe with various unblocking equipment.

### SUMMARY OF INVENTION

It is therefore an aim of the present invention to provide a check valve mechanism for rodents that addresses issues associated with the prior art.

It is a further aim of the present invention to provide a check valve mechanism for odors that addresses issues associated with the prior art.

Therefore, in accordance with the present invention, there is provided a check valve mechanism for use with a vertical drain pipe, comprising: a connector portion for supporting the check valve mechanism with respect to the drain pipe; and a first and a second flap each being an ungula of a cylindrical tube, the first and the second flap being pivotally connected to the connector portion, so as to be displaceable between a closed position, in which the first and second flaps are against one another such that peripheral portions of the first and the second flap are collinear at a connection line to obstruct the drain pipe, and an opened position, in which the first and second flaps are away from one another to allow liquids/solids to pass through the check valve mechanism, the first and the second flap.

### BRIEF DESCRIPTION OF THE DRAWINGS

Having thus generally described the nature of the invention, reference will now be made to the accompanying drawings, showing by way of illustration a preferred embodiment thereof and in which:

FIG. 1 is an elevation view of a check valve mechanism constructed in accordance with a first preferred embodiment of the present invention, with flaps in a closed position;

FIG. 2 is an elevation view of the check valve mechanism of FIG. 1, with the flaps in an open position;

FIG. 3 is a schematic perspective view of a flap as truncated from a cylindrical tube;

FIG. 4 is a schematic view of the check valve mechanism of FIG. 1, as positioned with respect to a toilet bowl fixture;

FIG. 5 is a top plan view of the check valve mechanism of FIG. 2;

FIG. 6 is an assembly view of the check valve mechanism of FIG. 1 with respect to a drain pipe;

FIG. 7 is an elevation view of a check valve mechanism constructed in accordance with a second preferred embodiment of the present invention, with flaps in a closed position;

FIG. 8 is an elevation view of the check valve mechanism of FIG. 7, with the flaps in an open position;

FIG. 9 is a schematic view of the check valve mechanism of FIG. 7, as used with a floor drain; and

FIG. 10 is an assembly view of the check valve mechanism of FIG. 7 with respect to a floor drain.

### DESCRIPTION OF THE PREFERRED EMBODIMENTS

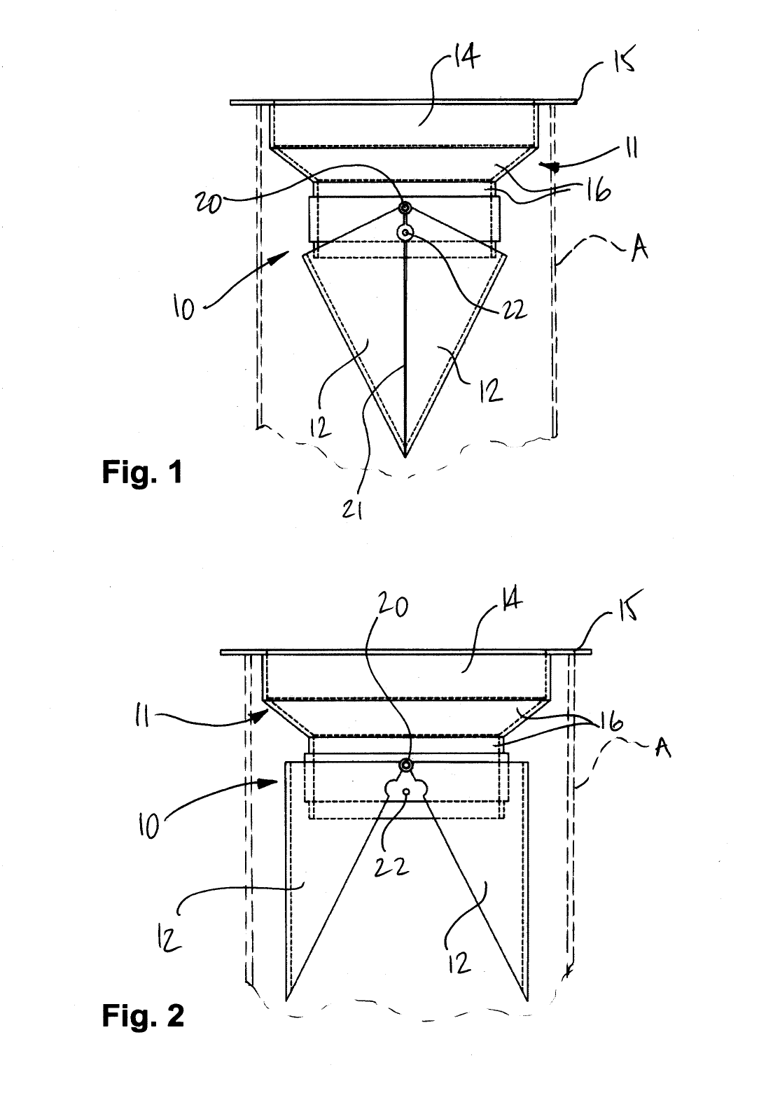

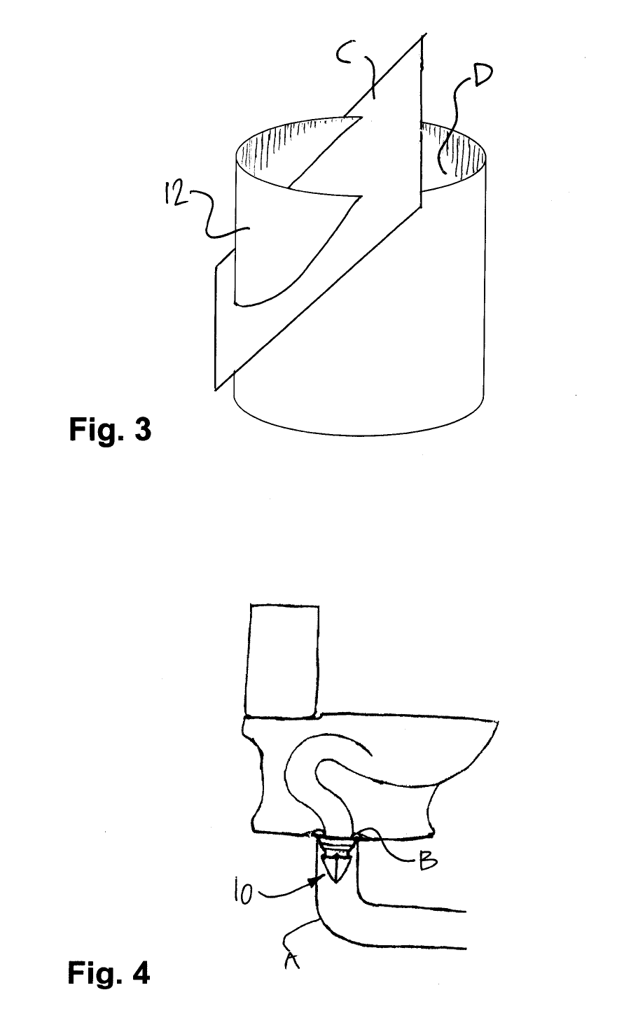

Referring to FIGS. 1 and 2, a check valve mechanism constructed in accordance with the present invention is generally shown at 10, with respect to a drain pipe A. The check valve mechanism 10 has a connector portion 11 and flaps 12, by which it will be connected to a drain pipe (as shown in FIGS. 4 and 6).

The connector portion 11 is provided as the interface between the flaps 12 the drain pipe A. The flaps 12 are pivotally mounted to the connector portion 11.

The flaps 12 form the barrier that will block the drain pipe A against infiltration by rodents. In an alternative embodiment, the flaps 12 will generally block odors.

The connector portion 11 has a tubular body 14 and a flange 15 at a top end of the tubular body 14. The tubular body 14 is sized so as to fit within the drain pipe. The flange 15, on the other hand, as a diameter larger than that of the drain pipe, so as to be seated on the drain pipe, as is shown in FIG. 4. It is shown in FIG. 4 that the check valve mechanism 10 is positioned between the drain pipe A and the wax ring B.

A throat portion 16 is optionally provided at a bottom end of the tubular body 14, and serves to centralize the flow of liquids and solids toward a center of the check valve mechanism 10.

The flaps 12 are each pivotally mounted to the connector portion 11 by way of pivots 20 (only one of which is visible in FIGS. 1 and 2). The flaps 12 each consist of a portion of a cylindrical tube. As shown in FIG. 3, a cutting plane C illustrates where the cylindrical tube D is truncated to form one of the flaps 12. In a preferred embodiment, each of the flaps 12 is an ungula of a cylindrical tube. An ungula is defined as a body bounded by two intersecting planes and a partially cylindrical surface of less than 360 degrees. The flaps 12 may be a special ungula of a right circular cylindrical tube by having the ungula defined by the two planes intersecting along the diameter of the cylindrical tube, with one of the planes being perpendicular to the axis of the cylindrical tube. This is the case for the embodiment illustrated in FIG. 3. Moreover, it is pointed out that the cylindrical tube preferably has a circular cross-section, but may have other arcuate and/or polygonal cross-section as well.

The flaps 12 are essentially identical, in such a way that the flaps 12 are collinear along connection line 21 (FIG. 1). The flaps 12 naturally go to this closed position by the effect of gravity on the flaps 12.

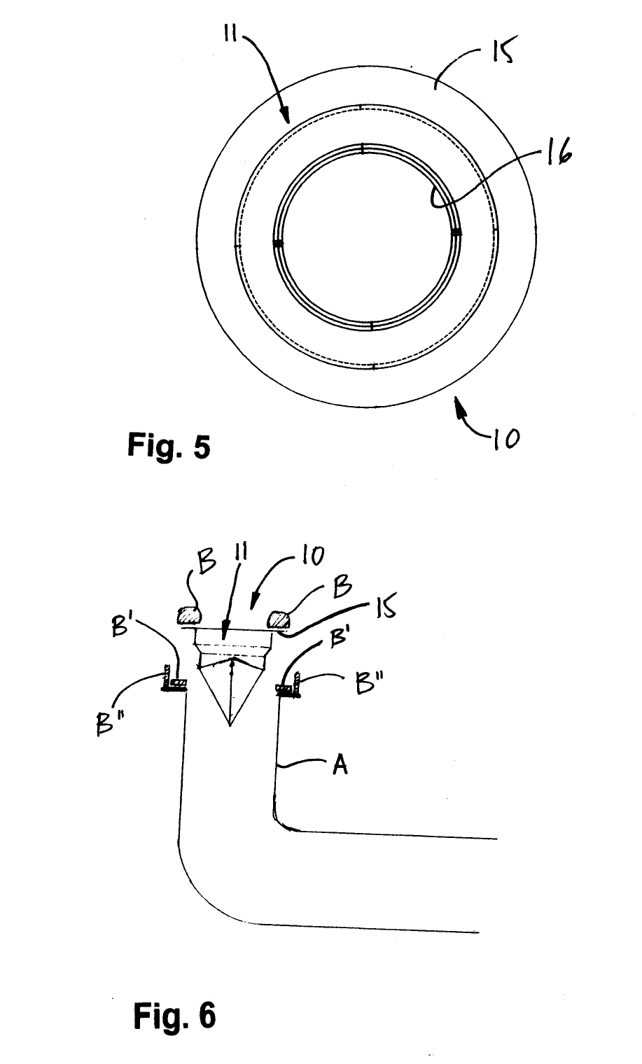

The shape of the flaps 12 is particularly advantageous when the flaps 12 are in an opened position (FIG. 2) to allow liquids and/or solids to pass therethrough. The flaps 12 pivot toward the inner periphery of the drain pipe A, and essentially conform to the circular cross-section of the drain pipe A. The flaps 12 in the opened position represent little disturbance against the flow of liquids/solids down the drain pipe A, as the flaps 12 in the opened position are hidden within a projection of the throat portion 16. This is clearly illustrated in FIG. 5, in which it is shown that the passage is unobstructed by the flaps 12 in the opened position.

A stop 22 is optionally provided to ensure that the flaps 12 meet in the opened position with the connection line 21 lying in a vertical plane.

As seen in FIG. 4, the check valve mechanism 10 is typically provided below the wax ring B against which the toilet bowl fixture is seated. The equipment used to unblock toilet bowls is typically sized in length not to go below the wax ring B. If the drain pipe is blocked, the toilet bowl can be removed, whereby the wax ring B and the check valve mechanism 10 can be removed to fit some equipment into the drain pipe A so as to unclog the drain pipe. As the check valve mechanism 10 is simply seated on an upper diameter of the drain pipe A, no fasteners are required, whereby the check valve mechanism 10 can simply be picked up. Alternatively, the flaps 12 may be pivotally mounted directly to the drain pipe A.

Referring to FIG. 6, a contemplated assembly of the check valve mechanism 10 is illustrated, with a gasket B′ (e.g., a rubber gasket or thin wax ring) being positioned below the flange 15 of the connector portion 11, while the wax ring B is above the flange 15. Bolts B″ are provided to secure the toilet bowl to the floor. It is considered to have the flange 15 imbedded in a wax ring. The check valve mechanism 10 could be sold with an imbedded wax ring.

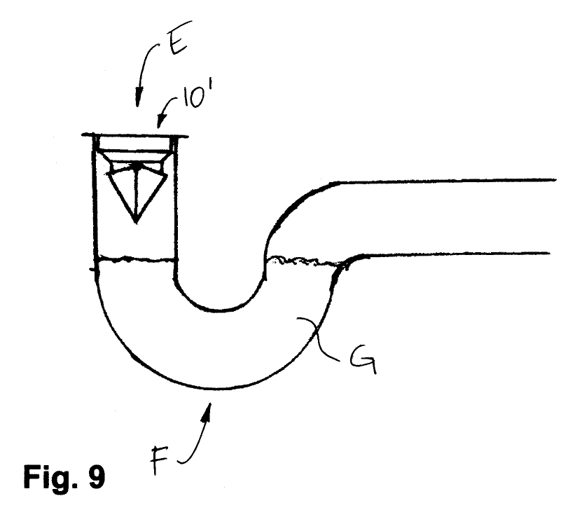

In another instance, illustrated by FIG. 9, the check valve mechanism 10′ is used to block odors emanating from a floor drain E. The check valve mechanism 10′ is similar to the check valve mechanism 10 of FIGS. 1 to 4, whereby like elements will bear like reference numerals. Floor drains E are typically provided with a siphon F that retains water G, so as to form a plug against the infiltration of odors. However, once the water evaporates, odors pass through the siphon F and infiltrate a room. This often occurs, considering that the typical homeowner is not aware that a siphon can safely be filled to block odors.

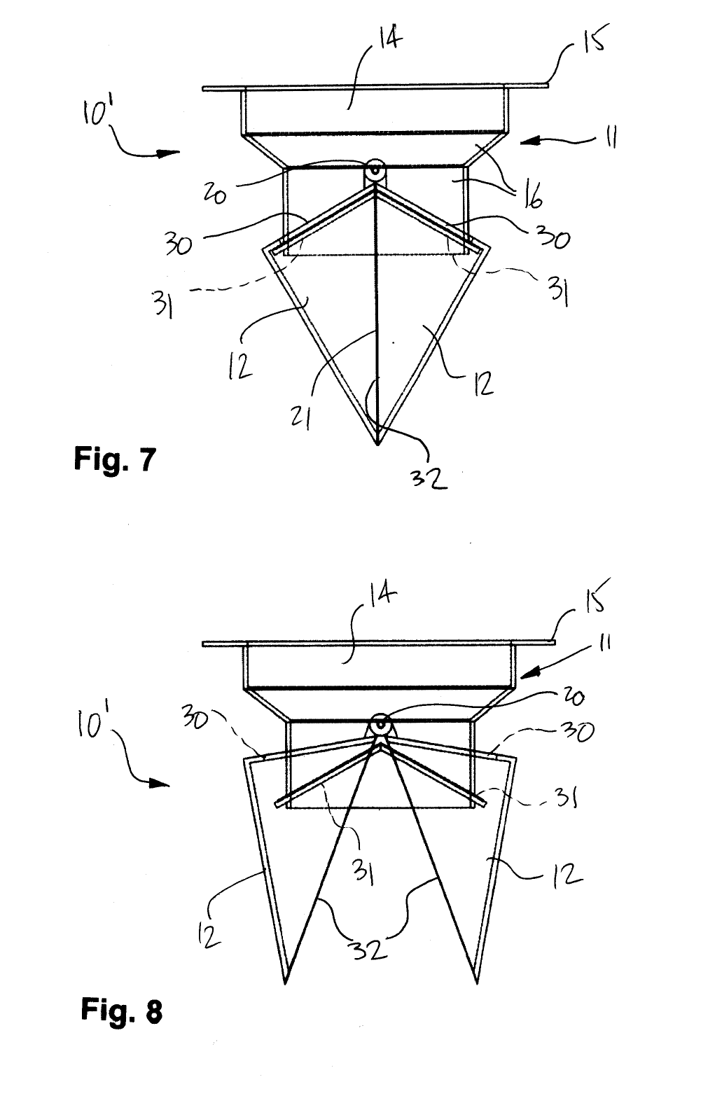

Referring to FIG. 7 to 10, in order to use the check valve mechanism 10′ against the infiltration of odors, a seal 30 is provided peripherally on an upper portion of both of the flaps 12.

Additionally, arcuate seals 31 (e.g., wiper seals, lip seals or similar types of seal) are provided on the outer periphery of the throat portion 16. Accordingly, when the flaps 12 are in the closed position (FIG. 7), the seals 30 cooperate with the seals 31 on the throat potion 16, thereby generally preventing odors from passing through. At the connection line 21 between the flaps 12, seals 32 are preferably provided to seal the connection line 21.

If water falls into the floor drain E, the flaps 12 temporarily pivot to the opened position illustrated in FIG. 8, to then return to the closed position of FIG. 7.

The floor drain E is therefore blocked, such that rodents and/or odors are prevented from passing through the check mechanism 10′.

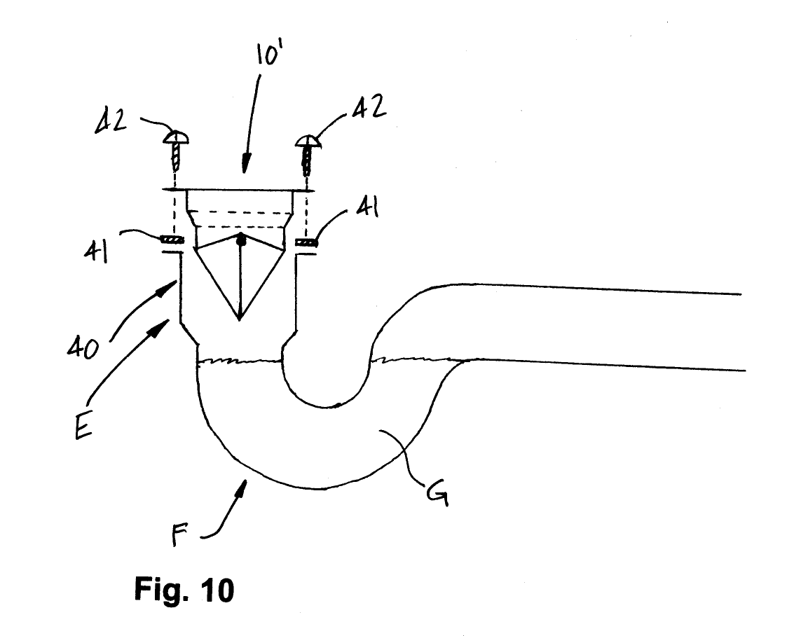

Referring to FIG. 10, it is considered to have a pipe enlargement 40, to ensure that the diameter of the floor drain, including the one of the check valve mechanism 10′, is within building code regulations. It is also shown in FIG. 10 that a gasket 41 (e.g., rubber gasket) can be used with the check valve mechanism 10′. The check valve mechanism 10′ is secured to the floor drain flange, for instance using screws 42.

1. A check valve mechanism and vertical drain pipe, comprising:
a drain pipe;
a connector portion for supporting the check valve mechanism with respect to the drain pipe; and
a first and a second flap each being an ungula of a cylindrical tube, the first and the second flap being pivotally connected to the connector portion and hanging freely from the connector portion when positioned on a drain pipe, so as to be displaceable between a closed position, in which the first and second flaps are against one another by the effect of gravity such that peripheral portions of the first and the second flap are collinear at a connection line to obstruct the drain pipe, and an opened position, in which the first and second flaps are separated from one another at the connection line by the pressure of liquids/solids moving downwardly through the check valve mechanism, the first and the second flap; the first and second flaps being sized with respect to the drain pipe such that a outer convex surface of each said flap is free from abutment contact with the connector portion and with the drain pipe between the closed position and the opened position.

2. The assembly according to claim 1, wherein each of the ungula of a cylindrical tube is a special ungula of a right circular cylindrical tube.

3. The assembly according to claim 1, wherein the first flap and the second flap pivot about a common axis.

4. The assembly according to claim 1, further comprising a stop on the connector portion, the stop being positioned with respect to the first and the second flap to limit the rotation of the first and the second flap at the closed position as caused by gravity.

5. The assembly according to claim 1, further comprising seals between an upper periphery of each of the first and second flap and the connector portion so as to seal air gaps between the flaps and the connector portion to block odors.

6. The assembly according to claim 1, wherein the connector portion has a flange subportion adapted to be suspended on a periphery of the drain pipe, and a cylindrical subportion with the flaps being pivotally mounted to an outer surface of the cylindrical subportion, the cylindrical subportion projecting below a pivot of the flaps and into a volume defined by inner concave surfaces of the flaps, the cylindrical subportion axially guiding liquids/solids through the check valve mechanism.

7. The assembly according to claim 6, wherein the cylindrical subportion of the connector portion has a throat, so as to define an annular volume about the throat in which the flaps will be positioned in the opened position.

8. The assembly according to claim 6, wherein the flange subportion of the connector portion has holes to be fastened to a surface adjacent to the drain pipe.

9. The assembly according to claim 6, wherein the cylindrical subportion of the connector portion has seals on its outer surface so as to sealingly contact the flaps in the closed position to seal air gaps between the flaps and the connector portion to block odors.

10. Use of the assembly of claim 1 with a drain pipe of a toilet bowl.

11. Use of the assembly of claim 1 with a drain pipe of a floor drain.

12. The assembly according to claim 1, comprising a cylindrical member suspended from the drain pipe and projecting below a pivot of the flaps and into a volume defined by the closed flaps, to axially guide the liquid/solids through the check valve mechanism.
